(19) United States
(12) Patent Application Publication
(10) Pub. No.: US 2011/0029616 A1
(43) Pub. Date: Feb. 3, 2011

(54) UNIFIED AUTO-REPLY TO AN EMAIL COMING FROM UNIFIED MESSAGING SERVICE

(76) Inventors: Guanming Wang, Edison, NJ (US); Xi Wang, Edison, NJ (US)

Correspondence Address: Guanming Wang, 54 Nevsky st, Edison, NJ, 08820, US

(21) Appl. No.: 12/511,938

(22) Filed: Jul. 29, 2009

(51) Int. Cl. G06F 15/16

(52) U.S. Cl. 709/206

(57) ABSTRACT

A system and method for providing an auto-reply message in response to an incoming message sent from a message sending device and delivered by a unified messaging service as an email encoded with information about the sending device's type and address. The incoming messages may be coming from email, fax, phone, text message, instant message, MMS, TV, or other communication devices. The auto-reply function of this invention is capable of replying to the messages regardless of what type of message sending device is used. The system is preferably implemented by integrating the new technologies of unified messaging service and unified message delivery service with the email tool, and by employing the new design methodology of cloud computing.

### FIELD OF THE INVENTION

This application relates generally to the field of auto-reply and unified messaging services. More particularly, the invention relates to a method of providing unified automatic reply to an email coming from a unified messaging service, and a system for executing the method.

### BACKGROUND OF THE INVENTION

Unified messaging services deliver email, fax, and voice message into email inbox. They are gaining popularity these days. Some examples of unified messaging services in use are: Microsoft Exchange 2010 (fax, phone, and email to inbox), eFax (fax to email), Vonage (voice mail to email), and txtForward (text message to email). Such services have made it more convenient for users to manage and retrieve a diverse array of incoming messages by centralizing the incoming messages to the users' email inbox regardless of the original medium of the message (fax, voice message or email).

Although centralizing the messages has brought about a new level of convenience, it has also created some new problems. In particular, it has become more demanding for a user to respond to all the incoming messages, especially when the user is out of the office.

For instance, some email clients (such as MS Outlook and IBM Lotus Notes) and web mails (such as Gmail) have an out-of-office email auto-reply feature. After the auto-reply switch is turned on, when someone sends in an email, the sender will receive an automatic email reply. But this auto-reply function is currently limited to email only, i.e., the email system can only handle incoming email messages, not fax, voice message, or messages coming from other types of devices such as text message, instant message, and TV. Moreover, the email auto-reply system can only reply by email, not by fax, phone, text message, instant message, or TV.

Therefore, there still exists a need for a way to automatically reply to incoming messages regardless of the message type and sending device.

### SUMMARY OF THE INVENTION

In view of the above, it is an object of the present invention to provide a novel approach capable of automatically replying to incoming messages coming from a unified messaging service.

It is also an object of the present invention to provide a system for automatically replying to an incoming message from a unified messaging service that is modular, and dynamic in nature so that existing technologies may be easily enlisted without requiring the creation of expensive new infrastructures.

At the heart of the invention is the concept of incorporating information regarding the device type and device address in each message delivered over unified messaging services so that the receiving device may be able to uniquely identify the sender and reply to the sending device with the appropriate response.

A unified messaging service handles messages generated by different types of devices such as email, fax, phone, text message (text), instant message (IM), and TV by transforming the messages into a uniform format (e.g email), and delivers the transformed messages to one destination (e.g. email Inbox). Such transformed messages will be referred to herein as “uniform messages.”

By incorporating information about the sender's device type (email, fax, phone, text, IM, TV, etc.) and device address (email address, fax number, phone number, text number, IM account, TV id, etc.) into the uniform messages, the receiving device may then respond to the incoming messages in accordance with a predetermined response protocol based on knowledge of the sending device's type and address.

Thus, in one aspect, the present invention discloses a method for providing an auto-reply message to an incoming message originating from a device and delivered by a unified messaging service as an email, wherein the email is encoded with information about the type and address of the device. Methods in accordance with embodiments of the present invention generally include the steps of: parsing the email to obtain information about the sending device's type and address; building an auto-reply delivery request for a unified message delivery service based on the information; and sending the delivery request to the message delivery service.

In some embodiments, the method may further include the steps of allowing a user to specify user preferences and saving the preferences into a data storage prior to receiving the email, wherein said user preferences include a general auto-reply flag and one or more auto-reply flags each corresponding to a different type of sending device; retrieving the user preferences from the data storage; and confirming that both the general auto-reply flag and the individual auto-reply flag corresponding to the device are on before sending the delivery request.

In another aspect, the present invention also discloses a system for providing an auto-reply message to an incoming message originating from a device and delivered by a unified messaging service as an email, wherein said incoming email is encoded with information about the device's type and address. Systems in accordance with embodiments of the present invention generally include an incoming email processor configured for parsing the email to obtain the information; building an auto-reply delivery request for a unified message delivery service based on the information; and sending the delivery request to the unified message delivery service.

The present invention extends the reach of auto-reply from email devices to other communication devices including phone, fax, text message (text), instant message (IM), TV, etc. In other words, the present invention extends the auto-reply from replying by email only, to replying by fax, phone, text, IM, TV, and other forms of communication. Systems and devices that use methods in accordance with embodiments of the present invention are capable of auto-replying to whichever device a message is sent.

Furthermore, users only need to type in the auto-reply message once. The same message will be sent out as plain text to email, fax, text, IM, TV, and other communication devices capable of receiving and displaying plain text, or be spoken out over the phone, TV, or other communication devices capable of receiving and playing audio streams, which may be generated by text-to-speech technology. In this way, the auto-reply message is consistent across all devices.

Advantages of the present invention include offering the unified auto-reply capability in the very important, useful, convenient, popular, and familiar environment—the email tool.

The present invention also retains the simplicity of the traditional out-of-office email auto-reply. Users do not need to change their working habits. They can simply type in an auto-reply message and turn on auto-reply as usual.

To most users, manually turning on auto-reply is not a drawback. Many people want to have control. They don't want to be controlled by a machine. They want to consciously “turn on the switch” and not be bothered to type in a message. In addition, auto-reply feature is not just used for out-of-office situations. Some people use the feature for email confirmation. In the case of unified auto-reply, some people want to use the feature for fax confirmation.

In short, embodiments of the present invention will have the advantage that they are easy to understand, implement, and expand.

Other aspects and advantages of the invention will be apparent from the following description and the appended claims.

### BRIEF DESCRIPTION OF THE DRAWINGS

FIG. 1 shows a block diagram of the system.

FIG. 2 shows a flow diagram of the processing implemented by the system of FIG. 1, according to an alternative embodiment of the present invention.

FIG. 3 shows a block diagram of the system according to an alternative embodiment.

### DETAILED DESCRIPTION

### Definitions

As used herein, the term “API” stands for Application Programming Interface and is used to refer to a set of functions that can be called from an application program to access features of another program.

As used herein, the term “Cloud Computing” refers to the utilization of services available in the cloud (i.e. Internet) and hosted by others, instead of hosting the services by oneself.

As used herein, the term “Device” is a generic term for a communication device such as phone, fax, email, text message, instant message, MMS, and TV, which is able to send and receive plain text, audio stream, and/or multimedia message.

As used herein, the term “Device Address” is a generic term for the identifier of a communication device. Examples are: phone number, fax number, text number, email address/email account/email return address, IM account, and TV id.

As used herein, the term “Device Type” refers to the type of communication device, such as phone, fax, text message, email, instant message, MMS, and TV.

As used herein, the term “Delivery Request” refers to a request submitted to a unified message delivery service, containing a multimedia message, a target device type, a target device address, and other data required by the service (such as user id and password), in the format defined by the service.

As used herein, the term “IM” stands for instant message.

As used herein, the term “MMS” stands for multimedia text message.

As used herein, the term “Text-to-speech” refers to the conversion of plain text into spoken words.

As used herein, the term “Unified Auto-Reply” refers to uniformly sending an auto-reply message back to any device that sends in a message.

As used herein, the term “Unified Message’ refers to an email coming from a unified messaging service, with the information of the type and address of the device (email, fax, phone, text message, MMS, instant message, TV, etc.) that the message originates from.

As used herein, the term “Unified Messaging Service” refers to a service that does the following:
(a) Receives and processes messages originating from different types of communication devices such as email, phone, fax, text message, instant message, MMS, and TV
(b) Transforms the messages into emails
(c) Identifies the origin of the device, i.e., device type and device address, and inserts the information into an email's subject line or body

As used herein, the term “Unified Message Delivery Service” refers to a service that takes different types of message delivery requests and sends them out to different types of devices.

As used herein, the term “Web Service API” refers to an API accessible over the Internet.

### Current State of Unified Message Delivery Services

Currently, the company 6Channel6 and several other companies have been providing unified message delivery service and have exposed the service as a set of web service API. Anyone wishing to use the service does not need to build/buy and host an entire system. Instead they can just use the web service API in their applications, passing delivery requests over the Internet to a service provider who will do the actual delivery.

6Channel6 has published the web service API for the delivery of email, phone, fax, text message (text), and instant message (IM). Once 6Channel6.com receives a delivery request, it will retrieve the delivery message, the type and address of target device from the request, and send out the delivery message to the target device via email, phone, text, IM, and fax delivery channels.

The delivery request includes plain text and/or a file of any kind. The plain text will be sent out as plain text to email, fax, text message, and instant message devices, or spoken out over the phone by text-to-speech. The file will be sent out as an attachment in emails and as hyperlink in instant messages. If the file is a “.wav” audio file, it will be played back over the phone.

The message is consistent across all channels.

U.S. patent application Ser. No. 11/637,050 to Lucent Technologies discloses a method of providing an automatic reply message. However, Lucent's solution did not utilize the new technology of unified messaging service and unified message delivery service. It was not possible for Lucent at the time since the technology was not yet available. Therefore, their system is a monolithic system with every piece of component needed.

Lucent's design methodology was old and did not take advantage of cloud computing, i.e., did not integrate services available on the Internet.

More recently, 6Channel6's unified inbox alert—6Alert6—went into production. 6Alert6 intercepts an incoming email from Outlook inbox, and through a web service API call, relays the email subject and body to 6Channel6.com, together with the information of the devices that user selected for receiving the alert. 6Channel6.com then delivers the email to the devices. The email subject and body are sent as plain text to a text, email, fax, or IM device, and spoken out over the phone by text-to-speech.

Through extensive market research, the inventor of the present invention has discovered that there is a previously unknown market demand for unified auto-reply fostered by users who were using unified messaging service and 6Alert6. These users became used to email confirmation and now they desire to do the same with fax confirmation.

In view of the discovery of the present invention, the inventor had devised the invention described herein to meet the needs of the users.

### Preferred Implementations

Since 6Channel6 already has unified message delivery service (6Channel6.com) and unified inbox alert (6Alert6) in production, it is technically feasible and relatively less challenging for those skilled in the art to construct an auto-reply system in accordance with the present invention by turning 6Alert6 into a functioning unified auto-reply application. Thus, it is preferred that embodiments of the present invention are implemented in a modular approach.

For example, one may add into a unified inbox alert the parsing of a sender's device type and address, and the passing of the device type and address along with the auto-reply message to a unified message delivery service. Similarly, MMS and TV delivery channels may also be added into the delivery service.

One important feature of the modular approach is that a monolithic system is not required, thereby, reducing the cost of implementation and maintenance. Furthermore, the present invention may be easily implemented by integrating the new technology of unified messaging service and unified message delivery service, thereby greatly simplifying the system.

The present invention also lends itself to the new and increasingly popular approach of computing—cloud computing—by calling the message delivery web service exposed in the cloud (i.e. Internet).

While keeping the simplicity of traditional out-of-office email auto-reply, the present invention extends the auto-reply function from only replying back to the sender's email device, to other types of devices including fax, phone, text message, instant message, TV, etc. To the inventor's best knowledge, this is first instance that the new technologies of unified messaging services and unified message delivery services are integrated with the traditional email tool by employing new design methodology cloud computing.

Because of the uniformity and simplicity of systems in accordance with embodiments of the present invention, expanding the system to support a new type of device in the future can be as simple as adding a string of the new device type, such as “newDeviceType” into a configuration file.

### Description of an Exemplary System

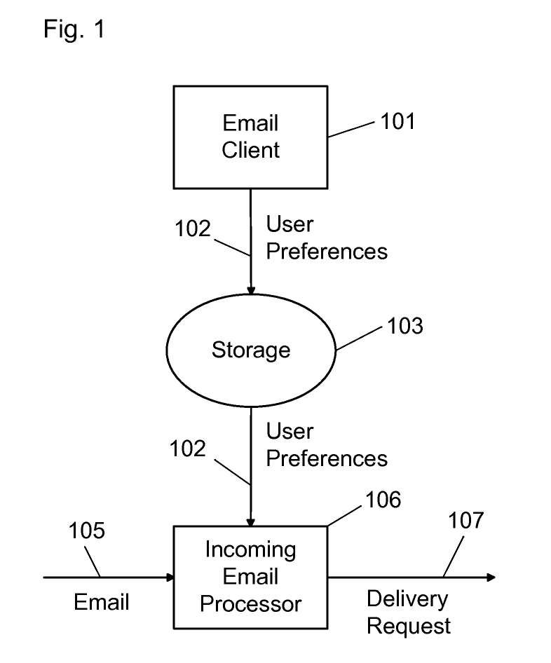

FIG.1 shows a block diagram of a computer system in accordance with embodiments of the present invention. The system includes an email client 101, a storage 103, and an incoming email processor 106.

Email client 101 provides an interface for a user to set up user preferences 102 and save user preferences 102 into storage 103. Email client 101 can be a web based application, or a stand alone program running on desktop, laptop, netbook, PDA, smart phone, BlackBerry, or any other computing devices.

User preferences 102 includes a general auto-reply flag, an individual auto-reply flag for each type of device (i.e., fax auto-reply flag, phone auto-reply flag, etc.), and an auto-reply message (plain text or multimedia including image, audio, video, rich text, etc.).

Storage 103 is used to store user preferences 102. It can be a database, collection of files, or any other combination of storage media and format commonly known in the art. The storage may also be either local or remote.

Email 105 is an email coming from a unified messaging service (not shown). The email is encoded with the type (device type) and the address (device address) of the device that generated the original message. The device type and address information are provided by the unified messaging service and are normally inserted into the email subject line in certain formats, such as “device type:device address” or “device type from device address”. Examples of device type and address are: “Fax:1234567890”, “fax from 1234567890”, “voice•mail:1234567890”, “text:1234567890”, “IM:msn:dummy@hotmail.com”, “yahoo:dummyYahooId”, “TV:dummyid”, “TV:1234567890”, etc. However, the encoding of the format is not particularly limited. Those skilled in the art will readily recognize that any suitable format may be used so long as the required information is encoded.

Delivery request 107 includes the auto-reply message, the sender's device type, and the sender's device address. It may optionally include other data (such as user id and password) required by a specific unified message delivery service (not shown) that is used to deliver the message.

Delivery request 107 should be formatted as defined by the unified message delivery service used.

Incoming email processor 106 processes email 105 and sends out delivery request 107, based on user preferences 102.

Incoming email processor 106 can be a standalone program running on either the server side or the client side. It may also be a plug-in for a server software or email client, or can be combined with email client 101 when running on the client side.

### Operation of an Exemplary System

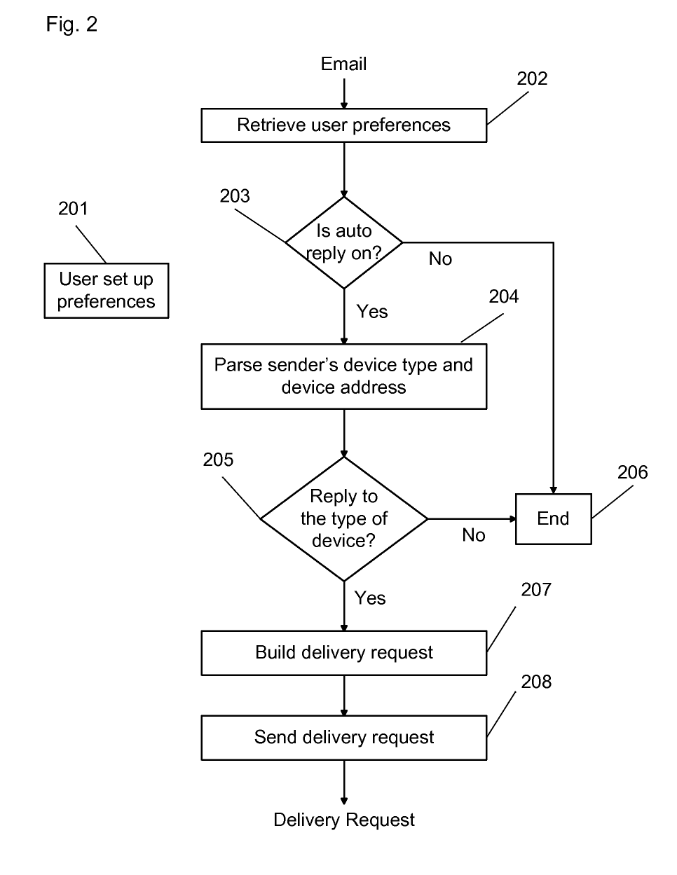

Using email client 101, a user specifies user preferences 102 by inputting the auto-reply message and turning on the auto-reply flags, and saves user preferences 102 into storage 103 (step 201 of FIG. 2).

When email 105 arrives in the Inbox, incoming email processor 106 first retrieves user preferences 102 from storage 103 (step 202 of FIG. 2), then checks to see if the general auto-reply flag of user preferences 102 is on (step 203). If the general auto-reply flag is not on, the process is ended (step 206).

If the general auto flag is on, incoming email processor 106 will parse the sender's device type and device address from the “return/from address” field and the “subject/body” field of email 105 (step 204). The email processor will then check to see if the individual auto-reply flag for the sender's device type (of user preferences 102) is on (step 205). For example, if the sender's device type is fax, email processor 106 will then check to see if the fax auto-reply flag is on. If the sender's device type is phone, then it will check the phone auto-reply flag. Similar procedures will be carried out for all known device types.

If the individual auto-reply flag for the sender's device type is not on, the process is ended (step 206).

Next, if the individual auto-reply flag for the sender's device type is on, incoming email processor 106 will build a delivery request 107. The delivery request 107 will incorporate information based on the auto-reply message of user preferences 102, the sender's device type, and the sender's device address. It may also optionally incorporate other data (such as user id and password) required by the unified message delivery service to be used, in the format defined by the delivery service (step 207).

Finally, incoming email processor 106 sends the delivery request 107 to the unified message delivery service through web service API call, TCP network socket, DotNet Remoting or Java RMI, ODBC or JDBC, or any other suitable means (step 208).

The unified message delivery service receives and processes the delivery request 107, and then delivers the auto-reply message to the sender's device through the predetermined delivery channels, i.e., email, fax, phone, text message, instant message, MMS, TV, etc.

### Alternative Embodiment

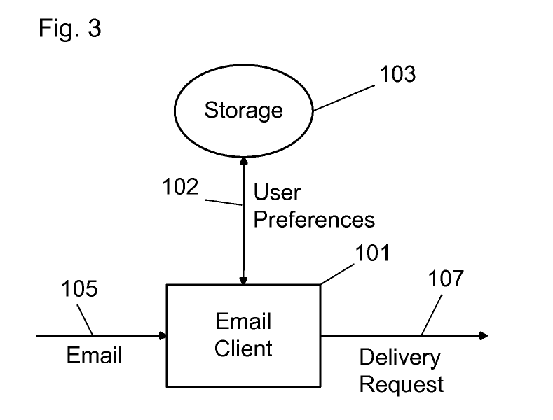

With reference to FIG. 3, an exemplary alternative embodiment of the present invention may be achieved by merging the incoming email processor 106 into email client 101.

Although the present invention has been described in terms of specific exemplary embodiments and examples, it will be appreciated that the embodiments disclosed herein are for illustrative purposes only and various modifications and alterations might be made by those skilled in the art without departing from the spirit and scope of the invention as set forth in the following claims.

What is claimed is:

1. A computer-implemented method for providing an auto-reply message in response to an incoming message sent from a message sending device, wherein said incoming message is delivered by an unified messaging service as an email encoded with information of the sending device's type and address, said method comprising the steps of:
parsing the email to obtain said information;
building an auto-reply delivery request for a unified message delivery service based on said information; and
sending said delivery request to said unified message delivery service.

2. The method of claim 1 further comprising the steps of:
allowing a user to specify user preferences and saving the user preferences into a data storage prior to receiving said email, wherein said user preferences comprises a general auto-reply flag and one or more auto-reply flags each corresponding to a different type of sending device;
retrieving said user preferences from said data storage; and
confirming that both the general auto-reply flag and the individual auto-reply flag corresponding to said device are on before sending said delivery request.

3. A computer-implemented system for providing an auto-reply message to an incoming message sent from a message sending device, wherein said message is delivered as an email encoded with information of the sending device's type and address, said system comprising:
an incoming email processor configured for:
parsing the email to obtain said information;
building an auto-reply delivery request for a unified message delivery service based on said information; and
sending said delivery request to said unified message delivery service.
